(19) United States
(12) Patent Application Publication
(10) Pub. No.: US 2018/0282069 A1
(43) Pub. Date: Oct. 4, 2018

(54) GECKO CARRIER

(71) Applicant: Ted Greg Lee Frumkin, Herzliya (IL)

(72) Inventor: Ted Greg Lee Frumkin, Herzliya (IL)

(21) Appl. No.: 15/568,824

(22) PCT Filed: Apr. 25, 2016
(86) PCT No.: PCT/IB2016/052335

§ 371 Date: Oct. 24, 2017

Related U.S. Application Data
(60) Provisional application No. 62/152,899, filed on Apr. 26, 2015.

(51) Int. Cl. B65G 15/30; B65G 15/58; B25J 15/00; C09J 201/00

(52) U.S. Cl. CPC B65G 15/30; B65G 15/58; C09J 2201/626; C09J 201/00; B25J 15/008

(57) ABSTRACT

The present disclosure describes carriers for carrying products, connected with reusable stickiness (adhesive) to grab and release different surfaces (products) and also includes the gecko conveyor, gecko cylinder, mechanical gecko arm etc. While the gecko's “glue” holds the product on the carrier strongly in one direction, one can easily pull the product out to the other direction and no extra motor or vacuum is needed, hence saving on costs and on extra parts that can be damaged. The shape of the product can be changed and is not necessarily symmetric. The carrier can come as a complete new product or the gecko adhesive can be as an add-on a belt of an existing carrier and includes a carrier that has reusable adhesive made out of carbon nanotubes mimicking a gecko foot. The present invention is directed to all carriers such as in factories, construction, cranes and conveyor belts in airports.

### FIELD OF THE INVENTION

The present invention generally relates to product or items (will be referred as product) carriers such as conveyors, mechanical arms, cranes etc. (will be referred as carriers) for transferring products from one location to the next, and in particular, it concerns reusable adhesive on the carrier for carrying the product.

### BACKGROUND OF THE INVENTION

In order to supply all the demands of the increasing human population, the industries need to become bigger and faster. For increasing the capacity factories (and other companies such as for construction air-prots etc.) use mechanical robotic conveyers, arms and cranes (or any other carriers) in order to move products from one location to the other. In order to pick the products with the mechanical arm, usually or vacuum or mechanical finger tips (fasteners that grabs the product) are used. Both techniques include extra operation to the movement of the mechanical or hydraulic arms, for example a pump to create the vacuum or extra engines for the mechanical finger tips. With this patent we propose a complete new and easy way to pick up products carry and transfer them to different location without any additional operation to the mechanical arm or conveyer, by using a material that has reusable stickiness to grab products, easy to connect and disconnect when needed, and doesn't leave any residue. All above saves energy grabbing the product (due to the lack of extra pump or motors) and thus saving costs, as well saving time and effort while grabbing and moving the product from one location to the other.

note, all materials that don't leave residue, have stickiness (by glue or other forces) that can grab products, and the stickiness doesn't wear off with water or even in dusty or damp conditions, the products can be easily freed and connected back again, can be used and will be referred as gecko “glue”.

Non-limiting exemplary embodiments of exemplary includes an adhesive imitating the geckos foot. The adhesive is made out of carbon nanotubes, it can hold on extremely strong in one direction, and can be easily freed on the other direction.

Geckos have the remarkable ability to cling to just about any surface, even something as smooth and slippery as glass. It's not due to suction, glue or Velcro-like bristles. Instead, geckos toe pads are covered with millions of tiny, flexible hairs. When a gecko plants its foot, the individual hairs come in extremely close contact with the surface is climbing on. That super-closeness makes it possible for atoms and molecules in the hairs to attract their counterpart atoms and molecules in the surface layer .

This attraction is called the Van Der Waals force (after the discoverer). The attraction is weak, but its effect is multiplied by the density and sheer number of hairs (or in the glue case the carbon nanotubes) on the gecko's toe pads. Each hair stalk, or seta, branches into hundreds of smaller, flattened tips called spatulae. The setae are able to shed dirt and to an extent, water, meaning a gecko's stickiness doesn't wear off even in dusty or damp conditions. To unstick its feet a gecko curls its toes upward (the other direction), peeling the setae away from the surface.

Referring to FIG. 1, inspired from the structure found on gecko feet, an optional embodiment synthesized carbon nanotube-based hierarchical hairy structure. Carbon nanotubes can be synthesized using chemical vapor deposition. Image of scanning electron microscope (SEM) of pillars of carbon nanotubes.

Referring to FIG. 2, non-limiting example patterns of pillared size ranging from 50-500 μm. The patterns act as setae and individual carbon nanotubes as spatula. These vertically aligned nanotubes can be transferred onto a polymeric substrate (the geometry would be referred as gecko tape). By optimizing the pattern size and the size and height of carbon nanotubes, very high shear forces can be achieved. For a non-limiting example 50 μm pattern size with 200 μm carbon nanotube length showed four times higher adhesion than natural gecko foot.

### SUMMARY

The present invention is directed to all mechanical carriers (such as mechanical arm or conveyor that move products from one location to the other) that have reusable stickiness to connect or disconnect to the products without the use of extra operation (this way saving costs and energy).

In addition to the adapted mechanical gecko carrier noted above, the present invention also includes the use of a carbon nanotube “glue” imitating the gecko's foot, for connecting between the carriers and the products. The “glue” imitating the gecko's foot can connect between the product and the carrier easily and completely in one direction while the connection can be opened easily on the other direction. The gecko's “glue” can be reused and it doesn't wear off even in dusty or damp conditions, and doesn't leave any residue.

An additional advantage of the new inventive gecko carrier is the ability to lift products on directions that where unavailable with the regular techniques, by the easy and reusable connectivity. As well can deduct the vibrations of a product on the carrier.

In addition the gecko carrier can be adjusted in different shapes due to the gecko adhesive that allow products to be carried on the carrier. Non-limiting example is a gecko cylinder that can change easily the direction the product is moving.

This concept is applicable to all types of mechanical carriers, in factories, constructions, cranes, luggage conveyer belts for luggage at the airports etc.

As mentioned before our objective is to realize a new technique carrying, grabbing and moving the products by a conveyor or mechanical arm that has gecko adhesive or any other adhesive product which doesn't leave residue, reusable and easy to use. Not using traditional technics such as vacuum or mechanical finger tips, rather by a special adhesive.

In an exemplary, non-limiting embodiment the “glue” consist of the carbon nanotubes imitating the gecko's foot, can be on the mechanical arm facet for sticking the product to the mechanical arm (all sizes of mechanical arm such as the ones in factories, have machinery, constructions etc.) without additional mechanism. To disconnect between the mechanical gecko arm and the product, the mechanical gecko arm just need a pool to the opposite direction, and can be reusable.

The gecko “glue” on the mechanical carrier will be made by a thin layer (the thickness can be determined by the product, for example large scale products like in constructions, or for small scale products like products that are packed in packing machine) on the facet. The gecko “glue” can be dispersed on the facet part of the carrier or it can be added on the side part of the mechanical arm for picking the product in parallel. The gecko's “glue” can be dispersed only on certain locations for creating a good grip, thus saving gecko “glue” material

Additional advantage of the Gecko carrier is the ability to move products perpendicular and/or against gravity due to the adhesive properties and by that allowing the use of locations that where not usable before.

An additional advantage, the shape and size of the gecko carrier can be adjusted for different purposes, as needed such as a rolling cylinder or a conveyor that can grab and pass the products to different location etc.

### BRIEF DESCRIPTION OF FIGURES

FIG. 1: pillars of carbon nanotubes mimicking the setae.

FIG. 2: individual carbon nanotubes as the spatula.

FIG. 3: non-limiting example of the gecko conveyor, regular conveyor and the direction of products on the conveyors.

FIG. 4A: non-limiting example of gecko cylinder side view.

FIG. 4B: non-limiting example of gecko cylinder carrying products.

FIG. 5A: non-limiting example of the mechanical gecko arm.

FIG. 5B: non-limiting example of the mechanical gecko arm carrying a product.

### DETAILED DESCRIPTION

The principles and operation of the apparatus and method according to a present embodiment may be better understood with reference to the drawings and the accompanying description. A present invention is an apparatus for an adhesive carrier. The apparatus facilitates moving a product on a carrier, using an innovative gecko “glue”. The gecko carrier holds the surface of the product with reusable adhesive material that does not leave residue, in order to stick and unstick. The carriers shapes with the gecko adhesive can change due to the possibility of the gecko carrier to pick the products perpendicular to the ground (i.e. against gravity) unlike a regular carriers that can only move the products parallel to the ground (i.e. gravity holds the product on the conveyor) or use extra motor for holding tips or vacuum etc.

Current research in the field is focused on improving conventional technics such as different materials for saving costs, vacuum or finger grips for carrying products in unconventional direction. A gecko carrier can carry products in all directions parallel perpendicular or upside down compared to gravity without the use of an extra motor for grabbing or vacuum, thus saving on locations in factories airports etc. As well, the gecko carrier helps to avoid vibrations of the product while it is carried.

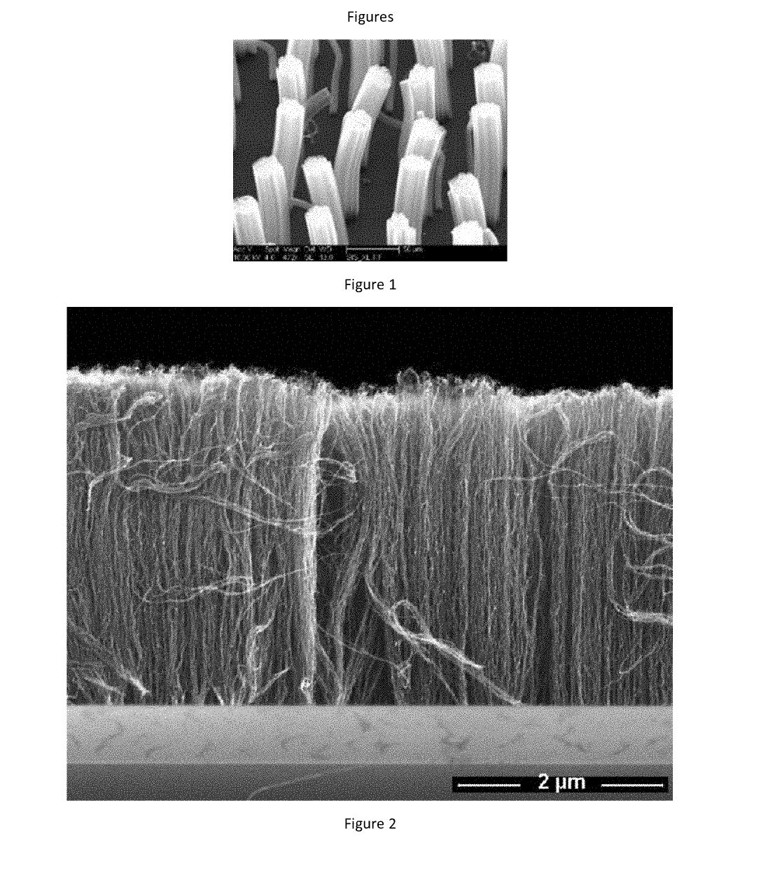

Refer to FIG. 1, non-limiting example of a top view SEM picture of pillars contain out of carbon nanotubes. The pillars act as the setae in order to create adhesive mimicking the gecko's foot. The pillars size and shape can be adjusted to a specific product in order to get the best adhesive.

Refer to FIG. 2, non-limiting example of a side view zoom of a pillar a cluster of carbon nanotubes, individual carbon nanotube can be seen. The individual carbon nanotubes act as the spatula in order to create adhesive mimicking the gecko's foot. The carbon nanotube size and height can be adjusted to a specific product demands.

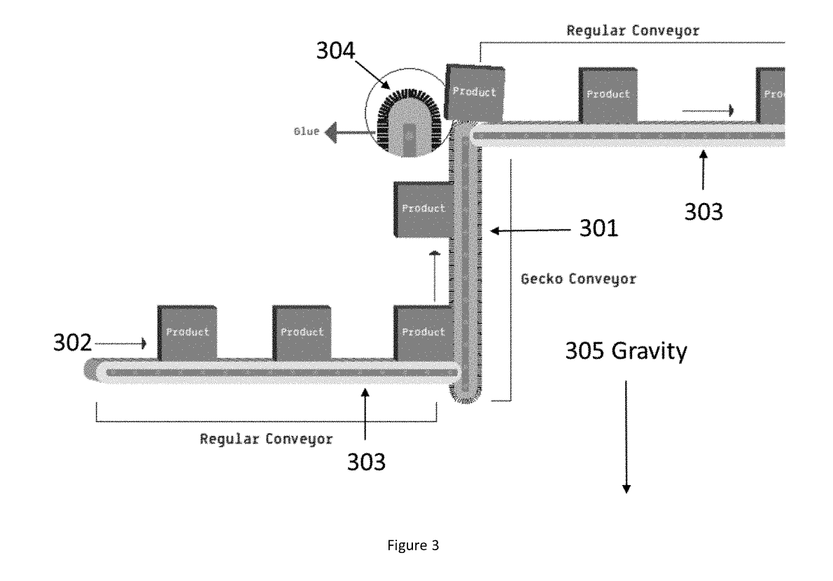

Refer to FIG. 3, non-limiting example of a conveyor with gecko adhesive 301. Note: the gecko conveyor can also pick the products 302 perpendicular to the ground or any other dirction i.e. against gravity 305 unlike a regular conveyor 303 that can only move the products parallel to the ground (i.e. gravity holds the product on the conveyor). The conveyor belt is covered by the gecko adhesive 304 (zoom on the facet of the conveyor belt with the gecko adhesive) in order to hold the product without the use of an extra motor or vacuum. The gecko conveyor can be adjusted as a new product or by adding the gecko adhesive to an existing conveyor belt. By using the gecko conveyor locations that where unreachable before can be used.

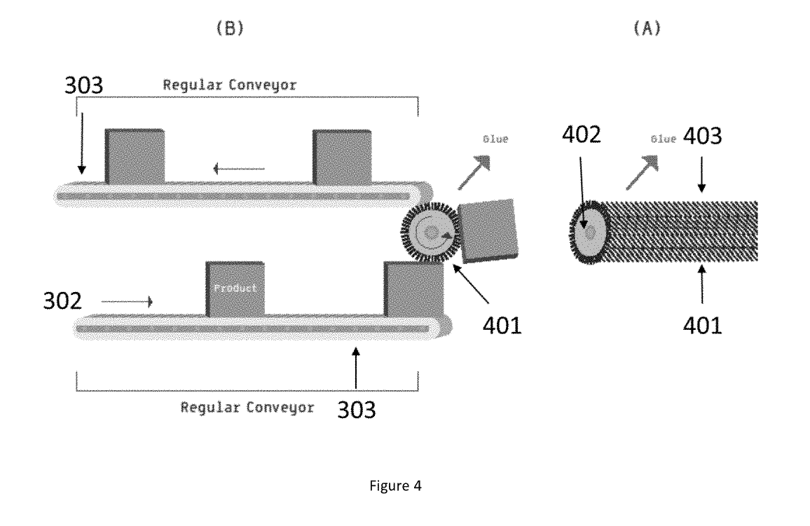

Refer to FIG. 4, non-limiting example of a gecko cylinder 401. (A) Gecko cylinder 402 side view covered by gecko adhesive 403. The cylinder belt is covered by gecko adhesive in order to grab products 302 without the use of an extra motor grabber or vacuum. (B) Non-limiting example of a system for products 302 that are moving in one direction (on a regular conveyer 303), are grabbed by the gecko cylinder 401 and moved to different direction, this way products can move on the vertical direction as well on the horizontal direction. (note: in this scenario the cylinder is moving counterclockwise).

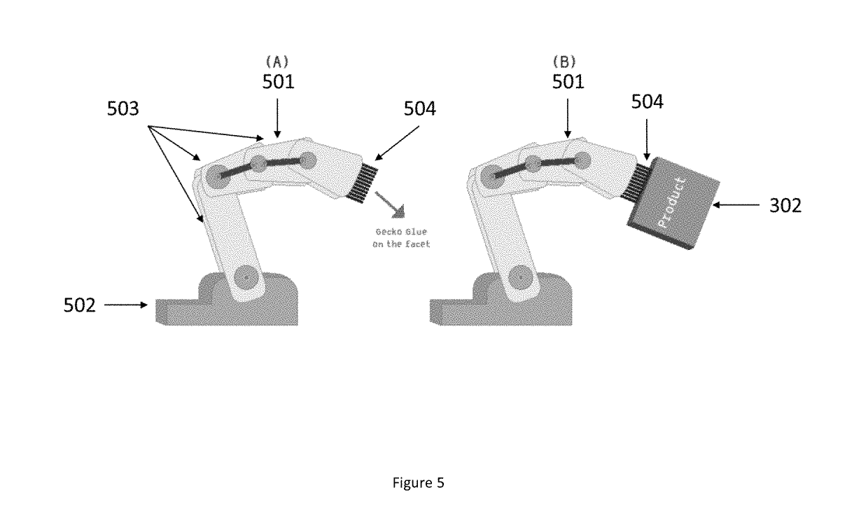

Refer to FIG. 5, non-limiting example of mechanical gecko arm 501. (A) Non-limiting example of a mechanical gecko arm 501 where the base 502 is stationary and it is connected to the mechanical arm 503 (note: there can be several arm parts that can move to different direction depending on the needs of moving the product). At the mechanical arm facet instead of having a griper or vacuum (that uses extra motors) gecko adhesive is added 504, the gecko adhesive can be added or dispersed on different locations (not only on the facet) on the mechanical arm depending on the way the product is grabbed. (B) A non-limiting example of a product 302 carried by a mechanical arm 501 at the facet with the gecko adhesive 504.

A gecko carrier has been shown to provide improved and easier way to move products compared to conventional techniques, and is a preferred implementation. Alternatively, the shape of the carrier can change due to the lack of extra motor or vacuum in order to grab the product. Both different directions and no vibration on the product can be achieved.

The choices used to assist in the description of this embodiment should not detract from the validity and utility of the invention. It is foreseen that more general choices including, but not limited to materials, different shape size and configuration can be used, depending on the application.

The use of simplified calculations to assist in the description of this embodiment should not detract from the utility and basic advantages of the invention.

It should be noted that the above-described examples, numbers used, and exemplary calculations are to assist in the description of this embodiment. Inadvertent typographical and mathematical errors should not detract from the utility and basic advantages of the invention.

It will be appreciated that the above descriptions are intended only to serve as examples, and that many other embodiments are possible within the scope of the present invention as defined in the appended claims.

What is claimed:

1. A carrier comprising:
a least one actuator or motor; and
a carrier-to-item contact surface including microstructure or nanostructure or picostructure based adhesive and adapted to reversibly adhere to a surface of the item.

2. The carrier according to claim 1, wherein said carrier-to-item surface is part of a conveyer belt.

3. The carrier according to claim 1, wherein said carrier-to-item surface is part of a robotic arm.
